(19) United States
(12) Patent Application Publication
(10) Pub. No.: US 2025/0270879 A1
(43) Pub. Date: Aug. 28, 2025

(54) Safety Handle for a Step Ladder

(71) Applicant: Matthew Horst Krupek, Nanaimo (CA)

(72) Inventor: Matthew Horst Krupek, Nanaimo (CA)

(21) Appl. No.: 18/588,274

(22) Filed: Feb. 27, 2024

(51) Int. Cl. E06C 7/18

(52) U.S. Cl. CPC E06C 7/183

(57) ABSTRACT

A safety handle for a step ladder is provided. The safety handle includes an elongated member having a first end and a second end. A first and second arm extend from the first end, wherein each arm includes a proximal end extending from the elongated member and a distal end. A C-shaped fastener, having an open end, is disposed on the distal end of each arm. In a secured configuration in which the safety handle is secured to a front side rail of the safety ladder, the open end of the fastener of the first arm is disposed on a plane parallel to a plane of the open end of the fastener of the second arm. The elongated member is disposed in a substantially vertical orientation and the second end thereof can be grasped when the safety handle is in the secured configuration.

### BACKGROUND OF THE INVENTION

The present invention relates to safety handles for ladders. The present invention further provides a safety handle comprising opposing fasteners that easily secure, and release as needed, from a step ladder, wherein the safety handle provides a substantially vertical grip when secured.

Ladders, including step-ladders, have been a fundamental tool for accessing elevated areas, both in domestic and professional settings. While conventional step-ladders serve their basic function, they often lack a dedicated safety handle, particularly designed for universal application. The absence of a standardized safety handle can pose significant risks, especially in scenarios where users need to step over the top of the ladder, such as navigating construction site staircases or reaching higher roof levels.

Existing step-ladders commonly lack a reliable safety handle, leaving users with a precarious grip or, in some instances, with no support at all. This deficiency becomes particularly apparent when individuals need to navigate unconventional ladder use, such as stepping over the ladder's top rungs. The inherent instability in such situations increases the likelihood of falls and injuries. Moreover, the lack of a universal clamping system means that available safety handles may not fit all step-ladder models securely, further compromising user safety.

In light of the devices disclosed in the known art, it is submitted that the present invention substantially diverges in design elements and methods from the known art and consequently it is clear that there is a need in the art for an improvement for a safety handle for a step ladder. In this regard the instant invention substantially fulfills these needs.

### SUMMARY OF THE INVENTION

In view of the foregoing disadvantages inherent in the known types of safety handles for a step ladder now present in the known art, the present invention provides a new safety handle for a step ladder wherein the same can be utilized for safety handle comprising opposing fasteners that easily secure, and release as needed, from a step ladder, wherein the safety handle provides a substantially vertical grip when secured.

It is an objective of the present invention to provide an embodiment of the safety handle comprising an elongated member having a first end and a second end. A first and second arm extend from the first end, wherein each arm includes a proximal end extending from the elongated member and a distal end. A C-shaped fastener, having an open end, is disposed on the distal end of each arm. In a secured configuration in which the safety handle is secured to a front side rail of the safety ladder, the open end of the fastener of the first arm is disposed on a plane parallel to a plane of the open end of the fastener of the second arm. The elongated member is disposed in a substantially vertical orientation and the second end thereof configured to be grasped when the safety handle is in the secured configuration.

It is another objective of the present invention to provide an embodiment of the safety handle configured to be universally applied to various ladders and step ladder models. The versatile clamping system ensures compatibility with different ladder structures and configurations. The elongated member for gripping enables a safe and seamless transition on and off the ladder, especially in situations requiring ladder traversal, allowing enhanced user convenience in accessing elevated areas with confidence.

It is therefore an object of the present invention to provide a new and improved safety handle that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of an embodiment of the safety handle.

FIG. 2 shows a close-up view of a second end of an embodiment of the safety handle.

FIG. 3 shows a front view of an embodiment of the safety handle secured to a ladder.

FIG. 4 shows a side view of an embodiment of the safety handle secured to a ladder.

### DETAILED DESCRIPTION OF THE INVENTION

Reference is made herein to the attached drawings. For the purpose of presenting a brief and clear description of the present invention, the preferred embodiment will be discussed as used for securing to a ladder for enhanced support. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment”, “an alternate embodiment”, “first embodiment”, “second embodiment”, or “third embodiment” does not necessarily refer to the same embodiment.

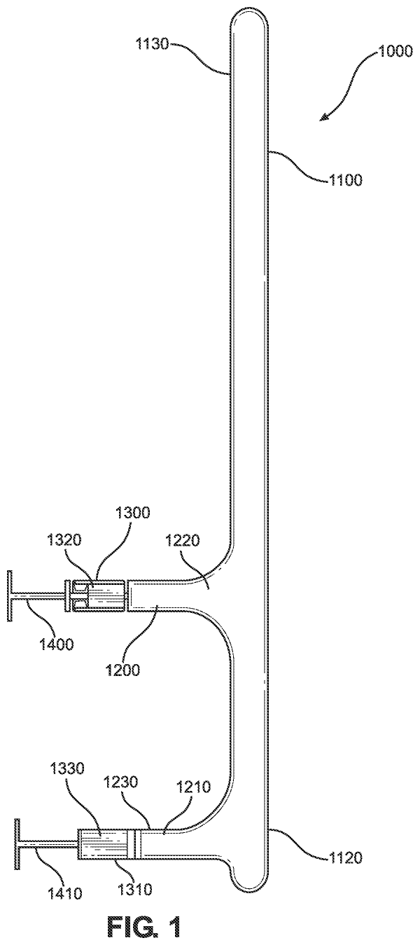

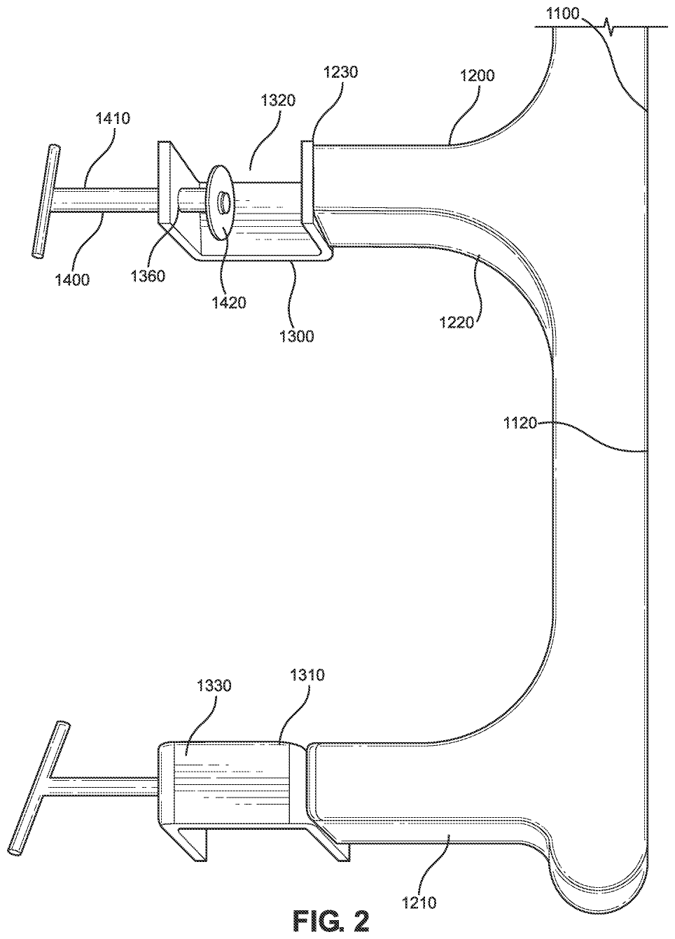

Referring now to FIGS. 1 and 2, there is shown shows a side view of an embodiment of the safety handle and a close-up view of a second end of an embodiment of the safety handle, respectively. The safety handle 1000 comprises an elongated member 1100 having a first end 1120 and an opposing second end 1130. The safety handle 1000 further comprises a first arm 1200 and a second arm 1210 extending from the first end 1120 of the elongated member 1100. The second end 1130 is attended to be grasped by a user. In the illustrated embodiment, the elongated member 1100 and the arms 1200, 1210 are composed of a rigid material. In some embodiments, the second end 1130 is coated to provide comfort to the user when grasped. In the illustrated embodiment, the elongated member 1100 is straight. However, in alternate embodiments, the second end of the elongated member is curved or indented to provide an ergonomic grip for the user.

Each arm 1200, 1210 comprises a proximal end 1220 extending from the elongated member and an opposing distal end 1230. In the illustrated embodiment, the first arm 1200, the second arm 1210, and the elongated member 1100 lie on a same plane. The first arm 1200 is positioned closer to the second end 1130 of the elongated member 1100. In the illustrated embodiment, the first end 1120 of the elongated member 1100 and the first and second arms 1200, 1210 form a U-shape. In the illustrated embodiment, the elongated member and arms are composed of any suitable rigid material, such as High-Density Polyethylene plastic (HDPE).

A pair of fasteners are disposed on the distal end 1230 of the arms 1200, 1210 for securing the safety handle 1000 to the step ladder. In the illustrated embodiment, a step ladder is defined as a folding ladder with flat steps and a small platform. However, the safety handle also secures to other types of ladders and platforms needing an additional safety handle for support. A first fastener 1300 of the pair of fasteners is disposed on the distal end 1230 of the first arm 1200 and a second fastener 1310 of the pair of fasteners is disposed on the distal end 1230 of the second arm 1210. In the illustrated embodiment, the first and second fastener 1300, 1310 each comprise an open end 1320 and an opposing closed end 1330. The open end 1320 is configured to receive a portion of the ladder. In the illustrated embodiment, each fastener is C-shaped, wherein the open ends 1320 extend between an entire width of a pair of opposing sidewalls 1340. In the illustrated embodiment, the first fastener 1300 and the second fastener 1310 are rotatably secured to the distal end of the first arm and second arm, respectively. The fasteners are configured to rotate 360 degrees. In alternate embodiments, the fastener is configured to pivot from side to side. In the illustrated embodiment, the fasteners are composed of stainless steel for strength and rigidity. In the illustrated embodiment, the C-Clamp dimensions are 4.7 mm thick, a 47 mm jaw opening, a 38 mm depth, and a 30 mm width. However, in alternate embodiments, the C-Clamp comprises any suitable dimensions configured to secure to a side rail of a step ladder.

In the illustrated embodiment, the first and second fastener 1300, 1310 each include a tightening member 1400 configured to secure the fasteners to the step ladder in the secured configuration. The tightening member 1400 comprises a rod 1410 that extends through an aperture 1360 in the sidewall of the fastener 1300, 1310 and is configured to apply force against the step ladder to secure the safety handle 1000 thereto. The rod 1410 comprises a T-shape and is threadedly engaged with the aperture 1360 of the fastener 1300, 1310. The T-shaped distal end of the rod 1410 provides a grip for the user to easily rotate the tightening member 1400. In some embodiments, the rod 1410 comprises a plate head 1420 that extends within the fastener 1300, 1310. The plate head 1420 is configured to abut with the ladder when secured thereto.

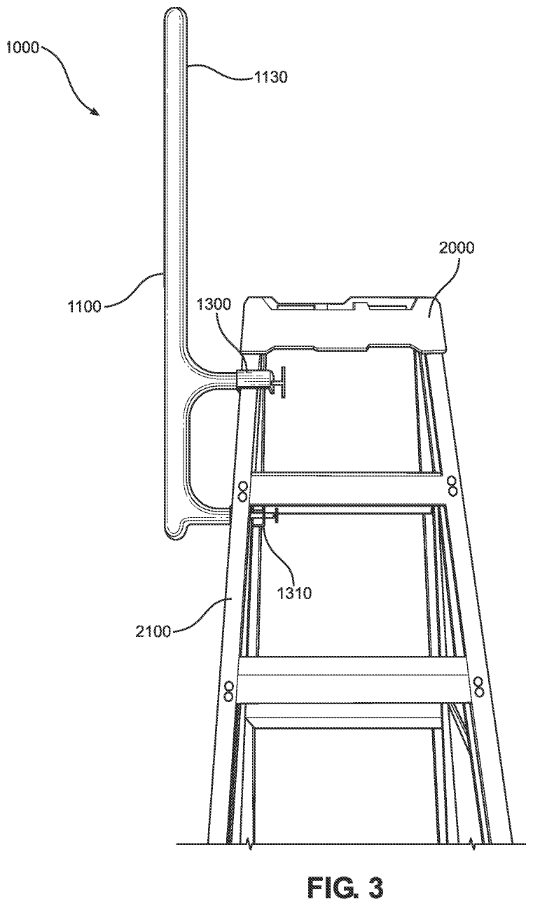

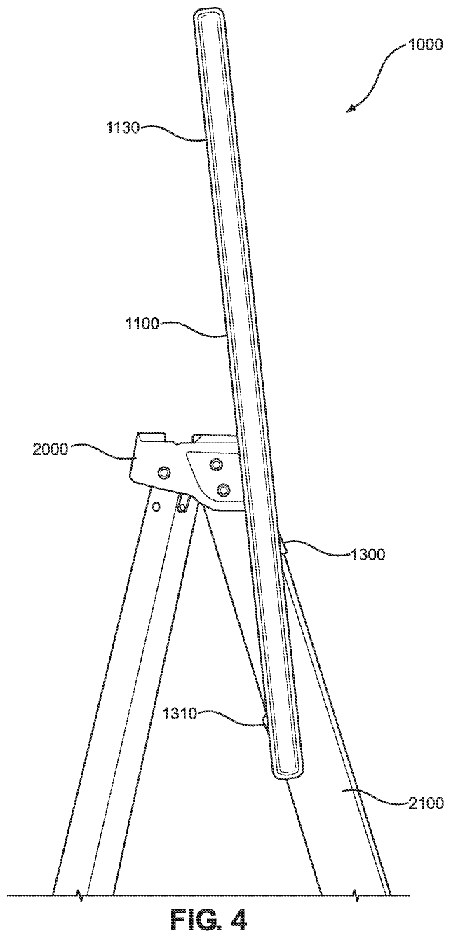

Referring now to FIGS. 3 and 4, there is shown a front view and a side view of an embodiment of the safety handle secured to a ladder, respectively. In the illustrated embodiment, in the secured configuration, the open end of the first fastener 1300 is disposed on a different plane than a plane of the open end of the second fastener 1310. In some embodiments, the planes of each open end of the first and second fasteners 1300, 1310 are parallel to one another because the fasteners are secured to opposite sides of a front side rail 2100 of the step ladder 2000, as seen in the illustrations. In the illustrated embodiment, in the secured configuration, the elongated member 1100 is disposed in a substantially vertical orientation and the second end thereof is configured to be grasped.

In the illustrated embodiment, the second end of the safety handle is approximately 4 to 5 inches away from the side rail 2100 of the ladder 2000. The arms 1300, 1310 are approximately 8 to 12 inches apart to allow the safety handle to be out of the way of the steps when the fasteners are secured to the rail 2100. In the illustrated embodiment, the fastener extending from the first arm 1300 is approximately 120 mm long and fastener attached to second arm 1310 is approximately 108 mm long. The purpose of the difference in length is to allow the elongated handle to secure in a substantially vertical orientation, and not have the elongated member follow the angle or profile of the ladder when in use. The vertical orientation of the elongated member creates a comfortable, safe, and effective handle. The c-clamps are mounted to the arms in opposing directions to achieve the most effective grip on as many different ladders as possible. The design of the C-clamp acts as a lock washer on the threads so it won't back off without significant force. In the illustrated embodiment, each C-clamp is attached to the arm with a pre-drilled and glued 2.5 inch flat-head Allen key screw. Each screw provides a shear strength of 300 lbs, two screws combined gives 600 lbs of shear strength.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A safety handle for a step ladder, comprising:
an elongated member having a first end and a second end;
a first arm and a second arm extending from the first end, wherein each arm comprises a proximal end extending from the elongated member and a distal end;
a first fastener disposed on the distal end of the first arm and a second fastener disposed on the distal end of the second arm;
wherein the first and second fastener each comprise an open end and an opposing closed end;
wherein a secured configuration the open end of the first fastener is disposed on a different plane than the open end of the second fastener;
wherein the elongated member is disposed in a substantially vertical orientation when secured to the ladder and the second end thereof is configured to be grasped when the safety handle is in the secured configuration.

2. The safety handle of claim 1, wherein the first and second fastener are C-shaped.

3. The safety handle of claim 1, wherein the open ends of each fastener extend between an entire width of a pair of opposing sidewalls.

4. The safety handle of claim 1, wherein in the secured configuration, the open end of the first fastener is disposed on a plane parallel to the open end of the second fastener.

5. The safety handle of claim 1, wherein the first fastener and the second fastener are rotatably secured to the distal end of the first arm and second arm, respectively.

6. The safety handle of claim 1, wherein the first arm, the second arm, and the elongated member lie on a same substantially vertical plane in the secured configuration.

7. The safety handle of claim 6, wherein the first arm is positioned closer to the second end of the elongated member.

8. The safety handle of claim 1, wherein the first end of the elongated member and the first and second arms form a U-shape.

9. The safety handle of claim 1, wherein the first and second fastener each include a tightening member configured to secure the fasteners to the step ladder in the secured configuration.

10. The safety handle of claim 9, wherein the tightening member comprises a rod that extends through a sidewall of the fastener configured to apply force against the step ladder in the secured configuration.

11. The safety handle of claim 10, wherein the rod comprises a plate head extending within the fastener.

12. The safety handle of claim 10, wherein the rod comprises a T-shape.

13. The safety handle of claim 10, wherein the rod is threadedly engaged with the fastener.

14. The safety handle of claim 1, wherein the secured configuration, the first fastener and the second fastener are disposed on opposing sides of a front side rail of the step ladder.

15. The safety handle of claim 1, wherein the elongated member is entirely straight.

16. The safety handle of claim 1, wherein the fastener is a C-clamp.

17. The safety handle of claim 1, wherein the first fastener is adapted to secure to an exterior side of a rail of the step ladder and the second fastener is adapted to secure to an interior side of the rail.

18. The safety handle of claim 17, wherein the secured configuration the rail received within the fasteners along is unparallel with the elongated member.
